(19) United States
(12) Patent Application Publication
(10) Pub. No.: US 2026/0320013 A1
(43) Pub. Date: Oct. 15, 2026

(54) SYSTEMS AND METHODS FOR ENRICHMENT OF VECTOR DATABASES

(71) Applicant: JPMORGAN CHASE BANK, N.A., New York, NY (US)

(72) Inventor: Bhavin J. SHUKLA, Piscataway, NJ (US)

(21) Appl. No.: 19/643,528

(22) Filed: Apr. 9, 2026

Related U.S. Application Data
(60) Provisional application No. 63/786,812, filed on Apr. 10, 2025.

(51) Int. Cl. G06F 16/22; G06F 16/23; G06F 16/2458; G06F 16/25; G06F 16/27

(52) U.S. Cl. CPC G06F 16/2237; G06F 16/2365; G06F 16/2462; G06F 16/256; G06F 16/27

(57) ABSTRACT

In some embodiments, the techniques described herein relate to a method including: building, by an application executed by one or more processors, a vector database (VD-1) with a data set A available to a first organization; sharing, by the application, VD-1 with a second organization; enriching VD-1 with new data from a data set B and use VD-1 as an input, to create VD-2; and storing, VD-1 and VD-2 in a distributed ledger.

### RELATED APPLICATIONS

This application claims priority to, and the benefit of, U.S. Provisional Patent Application Ser. No. 63/786,812, filed Apr. 10, 2025, the disclosure of which is hereby incorporated, by reference in its entirety.

### BACKGROUND

### 1. Field of The Invention

Embodiments generally relate to systems and methods for enrichment of vector databases and providing support for auditability.

### 2. Description of the Related Art

Large volumes of data may be used to generate usable and meaningful vector databases for artificial intelligence and machine learning applications, including retrieval, similarity search, and information access tasks. In many environments, a single organization may have access to its own first-party data, while additional relevant data may be controlled by other organizations as second-party or third-party data. As a result, development of a sufficiently comprehensive vector database may depend on incorporating data that resides across organizational boundaries.

Existing techniques for obtaining such broader coverage rely on data-transfer batch jobs, real-time messaging protocols, and other integration mechanisms to move or replicate data between systems. Although such arrangements may enable use of data from multiple sources, they may become impractical, error-prone, and operationally complex as the number of participating systems and datasets increases. These approaches also tend to create multiple copies of data in multiple locations, which may increase storage burdens, complicate governance, and make synchronization more difficult.

Construction of a vector database may also be computationally intensive because large amounts of source data are processed to generate vectorized representations and related index structures. Under some approaches in which newly available data is copied across organizational boundaries, the receiving system may rebuild the vector database from the beginning each time the underlying data is updated or expanded. Repeated full reconstruction of the vector database may consume substantial compute resources, introduce delay, and reduce the practicality of keeping the vector database current.

Additional challenges arise when intermediate versions of a vector database need to be preserved, traced, or later reviewed. In environments involving multiple systems or organizations, determining which data contributed to a particular version of the vector database, whether a retrieved version is authentic, and how the vector database evolved over time may be difficult. Accordingly, techniques are needed that support incremental enrichment of vector databases across systems while also supporting reliable retrieval, traceability, and auditability of intermediate states and resulting versions.

### SUMMARY

Exemplary embodiments provide systems and methods for enrichment of vector databases and providing support for auditability including steps of a method including building, by an application executed by one or more processors, a first vector database (VD-1) with a data set A available to a first organization; sharing, by the application, VD-1 with a second organization; enriching VD-1 with new data from a data set B and use VD-1 as an input, to create VD-2; and storing, VD-1 and a second vector database (VD-2) in a distributed ledger.

In some embodiments, a computer-implemented method is provided for incrementally enriching a vector database across organizational computing systems while preserving retrievability and auditability of intermediate vector database states. A first computing system may receive a first data set associated with a first organization, generate a first vector database from the first data set, and store the first vector database in a distributed ledger. The first vector database may be transmitted to a second computing system associated with a second organization. The second computing system may receive a second data set associated with the second organization and perform a correlation operation on a first set of vectors of the first vector database and a second set of vectors of the second data set by generating linear combinations of the respective sets of vectors and identifying pairs of directions such that projections onto the pairs of directions are as correlated as possible.

Based on the correlation operation, the second computing system may enrich the first vector database with the second data set to generate a second vector database, store the second vector database in the distributed ledger, and retrieve the first vector database or the second vector database from the distributed ledger to audit an intermediate state of vector database enrichment.

In some embodiments, the distributed ledger may be a federated distributed ledger. Integrity of a transmitted vector database may be verified using a checksum check performed after transmission and before enrichment. The enrichment may use the first vector database as an input to generate the second vector database. Authenticity of a retrieved vector database may be verified by comparing a checksum of the retrieved vector database with checksum information associated with the distributed ledger.

In some embodiments, the correlation operation may include generating linear combinations of vectors from a first set of vectors and a second set of vectors and selecting a pair of directions having a correlation between projections that is greater than correlations for other candidate pairs of directions. In some embodiments, validation of the enriched vector database may include execution of an application programming interface suite against different vector database versions, where a first subset of application programming interface calls passes and a second subset fails for the first vector database, while application programming interface calls in the application programming interface suite pass for the second vector database.

In some embodiments, the second vector database may further be validated using an approximate neighbor-search library. Additional embodiments are directed to a system and a non-transitory computer-readable medium configured to perform corresponding operations for incrementally enriching a vector database across organizational computing systems while preserving retrievability and auditability of intermediate vector database states.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for enrichment of vector databases and providing support for auditability, in accordance with embodiments.

FIG. 2 is a block diagram of a method for enrichment of vector databases and providing support for auditability, in accordance with embodiments.

FIG. 3 is a block diagram of a method for enrichment of vector databases and providing support for auditability, in accordance with embodiments.

FIG. 4 is a block diagram of a computing device for implementing certain aspects of the present disclosure.

### DETAILED DESCRIPTION

Embodiments generally relate to systems and methods for enrichment of vector databases and providing support for auditability.

Techniques and systems described herein may include incrementally enriching vector databases while keeping the intermittent states auditable. There should be ability to share vector databases across systems, have each system enhance it and add the intermittent states to a distributed ledger for audit and traceability purposes.

In some embodiments, systems and methods are provided for incremental enrichment of vector databases with support for auditability, traceability, and retrieval of intermediate states. A first computing environment may generate a first vector database from a first data set available to a first organization. The first vector database may then be shared with a second computing environment associated with a second organization. Rather than rebuilding a vector database from scratch when additional data becomes available, the second computing environment may use the first vector database as an input and enrich the first vector database with a second data set to generate a second vector database. In this manner, vector databases may be progressively enhanced across organizational boundaries while reducing repeated full reconstruction operations.

In some embodiments, a given version of the vector database, including the first vector database and the second vector database, may be stored in a distributed ledger, such as a federated blockchain-based ledger, to support authenticity verification, traceability, and audit of interim and resulting states. The distributed ledger may enable a node to retrieve a selected version of a vector database and verify that the selected version corresponds to an expected state of enrichment. In some embodiments, integrity checks, including checksum-based checks, may be used when sharing or retrieving a vector database across systems.

In some embodiments, correctness and coverage of enriched vector databases may be evaluated using an application programming interface suite configured to query different versions of the vector database. A first subset of application programming interface calls may succeed against an earlier vector database version while one or more other calls may fail due to absence of later-added data, and a larger set of application programming interface calls may succeed against a later enriched vector database version. Such testing may be used to identify hallucinations, validate enrichment results, and confirm that later vector database versions provide broader or more comprehensive retrieval functionality than earlier versions.

In some embodiments, enrichment validity may further be evaluated using k-closest-neighbor techniques or other similarity-processing libraries. Accordingly, the disclosed systems and methods may provide for sharing vector databases, enriching vector databases with newly available data, and storing and retrieving auditable versions of vector databases from a distributed ledger.

In some embodiments, the disclosed systems and methods may reduce computational overhead associated with maintaining vector databases. Building vector databases may require processing large amounts of data and may, as a result, be compute-intensive. By sharing an in-progress vector database across organizations and enriching the in-progress vector database with organization-specific data, a later vector database version may be generated using an earlier vector database version as an input, rather than rebuilding the vector database from scratch each time additional data becomes available.

In some embodiments, the disclosed systems and methods may reduce operational complexity associated with obtaining broader data coverage across organizational boundaries. Conventional approaches may rely on data-transfer batch jobs and real-time messaging protocols to access second-party or third-party data, which may become impractical, error-prone, and operationally complex and may require multiple copies of data to exist in multiple places. By comparison, a vector database generated from data available to one organization may be shared with another organization and incrementally enriched using data available to the other organization.

In some embodiments, the disclosed systems and methods may improve auditability, traceability, and retrievability of vector database states. Each version of the vector database may be added to a distributed ledger, such as a federated distributed ledger or blockchain-based ledger, so that an interim state or a later enriched state may be retrieved for audit purposes. Storage of successive vector database versions in the distributed ledger may permit a node to retrieve or audit a selected state with a high degree of confidence.

In some embodiments, the disclosed systems and methods may improve integrity verification associated with sharing and retrieval of vector databases. For example, checksum checks may be used when a vector database is shared across organizations, and authenticity of a retrieved vector database may be verified from the distributed ledger. Such arrangements may support reliable use of intermediate and enriched vector database states across distributed computing environments.

In some embodiments, the disclosed systems and methods may improve validation of correctness and completeness of vector databases. An automated application programming interface (“API”) suite may be used to retrieve information from different vector database versions. Specific APIs may pass when invoked against an earlier vector database version and other APIs may may when information is not yet represented in an earlier vector database version, while all APIs in the API suite may pass when invoked against a later enriched vector database version. In some embodiments, hallucinations may be checked during execution of the API suite, and approximate neighbor-search techniques or other libraries may be used to check validity of the enriched vector database.

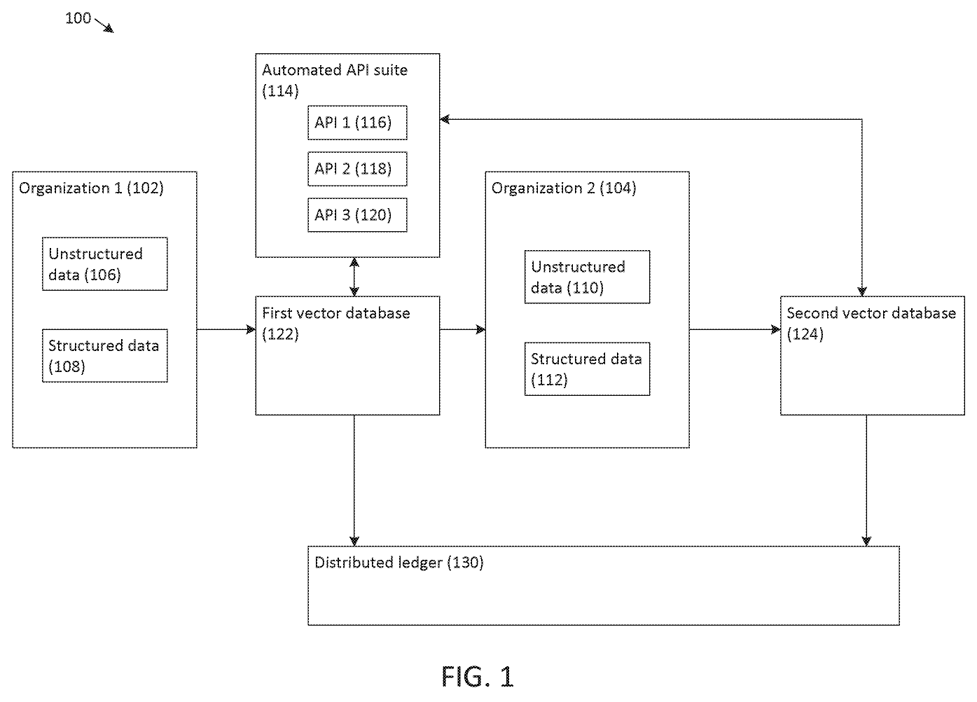

FIG. 1 illustrates a system 100 for incremental enrichment of vector databases with support for auditability. In some embodiments, the system 100 may include a computerized system of a first organization 102 and a computerized system of a second organization 104. The computerized system may comprise one or more processors and a memory configured to store instructions to be executed by the one or more processors.

The first organization 102 may have access to and/or store one or more data sources, such as unstructured data 106 and structured data 108. The unstructured data 106 and the structured data 108 may be processed to generate a first vector database 122. The first vector database 122 may integrate the unstructured data 106 and the structured data 108. In some embodiments, the first vector database 122 may represent a first-stage vectorized repository derived from data available to the first organization 102. The first vector database 122 may be shared with the second organization 104, which may also have access to additional data sources, such as unstructured data 110 and structured data 112. The second organization 104 may use the first vector database 122 as an input and may further process the unstructured data 110 and the structured data 112 to generate a second vector database 122 enriched relative to the first vector database 122.

In some embodiments, the system 100 may further include an automated application programming interface (“API”) suite 114 configured to evaluate one or more versions of the vector database. The automated API suite 114 may include one or more application programming interfaces, such as API 1 116, API 2 118, and API 3 120. Although three APIs are shown, it is anticipated that any number of APIs may be used. Each API (e.g., API 1, API 2, API 3) may be configured to provide a method call comprising a query, and may be configured to receive a response from one or more vector databases. The automated API suite 114 may be configured to issue the query against the first vector database 122 and the second vector database 124 to assess correctness, completeness, or both. In some embodiments, one or more APIs of the automated API suite 114 may successfully retrieve information from the first vector database 122, while one or more other APIs may fail when data corresponding to the query is not present in the first vector database 122. After enrichment, a greater number of APIs, or all APIs in the automated API suite 114, may succeed when executed against the second vector database 124. Thus, second vector database 124 may be validated.

The system 100 may further include a distributed ledger 130. In some embodiments, the distributed ledger 130 may store the first vector database 122, the second vector database 124, or representations thereof, so that intermediate and enriched states of the vector database may be retrieved and audited. The distributed ledger 130 may be implemented as a federated distributed ledger, a blockchain, and/or another distributed record structure that supports traceability and authenticity verification. As shown in FIG. 1, the first vector database 122 may be written to the distributed ledger 130 after generation, and the second vector database 124 may likewise be written to the distributed ledger 130 after enrichment. In this manner, the system 100 may support cross-organizational sharing of in-progress vector databases, incremental enrichment using organization-specific data, and auditable preservation of successive vector database states.

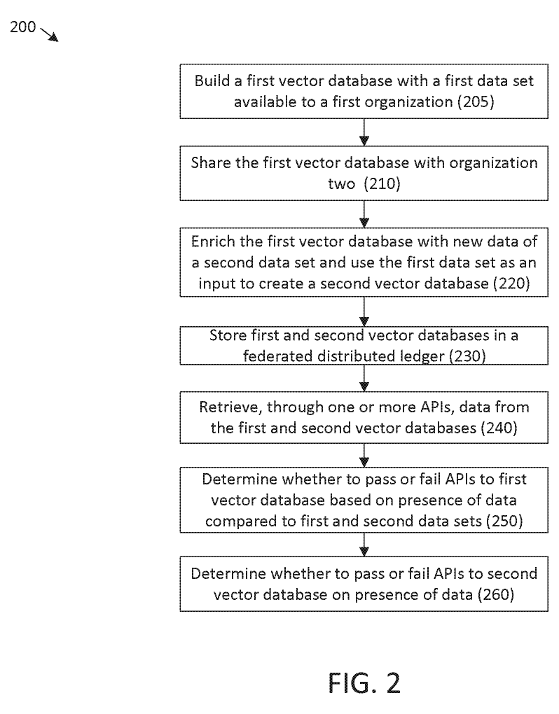

FIG. 2 illustrates a method 200 for incremental enrichment of a vector database and validation of resulting vector database states. At 205, a first computing system may build a first vector database (e.g., first vector database 122) with a first data set available to a first organization. The first data set may include one or more structured or unstructured data sources, and the first vector database may include vectorized representations derived from the first data set. At 210, the first vector database may be shared with a second organization. In some embodiments, sharing may include transmitting the first vector database, a representation of the first vector database, and/or an addressable instance of the first vector database to a computing environment associated with the second organization.

At 220, the second organization may enrich the first vector database with new data of a second data set and may use the first vector database as an input to create a second vector database (e.g., second vector database 124). In some embodiments, the second vector database may preserve information already represented in the first vector database while incorporating additional information derived from the second data set. At 230, the first vector database and the second vector database may be stored in a federated distributed ledger. Storage in the federated distributed ledger may permit subsequent retrieval of different vector database states and may provide traceability for audit purposes.

At 240, data may be retrieved from the first vector database and the second vector database through one or more APIs. In some embodiments, the APIs may correspond to an automated API suite configured to test whether requested information is available from a given vector database state. At 250, the method 200 may determine whether to pass or fail APIs to the first vector database based on presence of data as compared to the first data set and the second data set. For example, an API directed to information represented in the first data set may pass when executed against the first vector database, while an API directed to information absent from the first data set but represented in the second data set may fail when executed against the first vector database. At 260, the method 200 may determine whether to pass or fail APIs to the second vector database based on presence of data. Because the second vector database has been enriched with the second data set, APIs that depend on information from either the first data set or the second data set may pass when executed against the second vector database. Accordingly, FIG. 2 illustrates an example workflow in which vector database construction, cross-organizational enrichment, distributed-ledger storage, and API-based validation are performed in a coordinated manner.

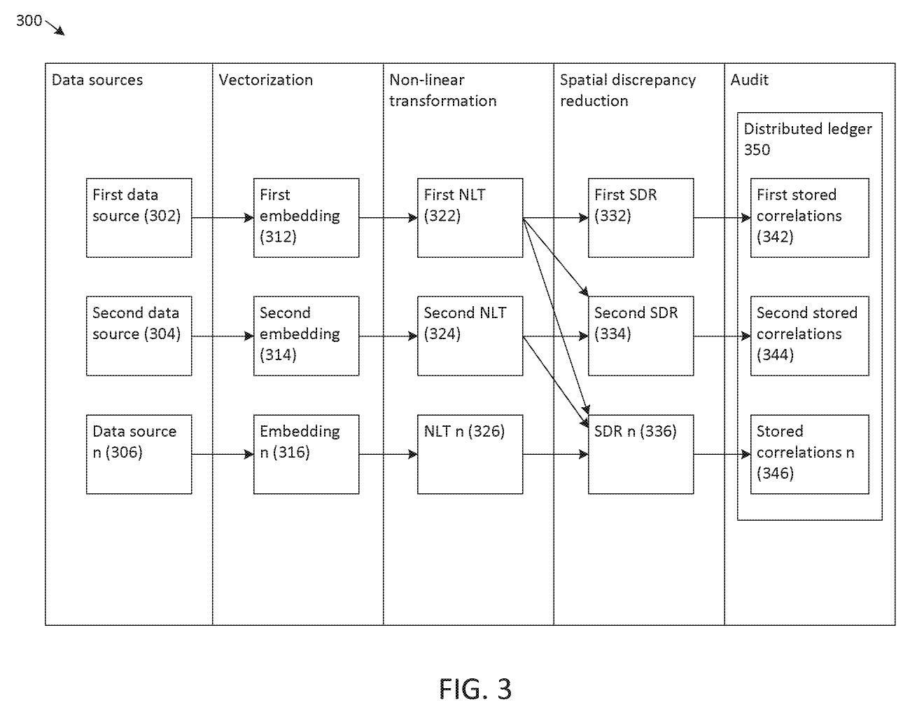

FIG. 3 illustrates a processing architecture 300 for generating and storing correlations used in vector database enrichment. In some embodiments, the processing architecture 300 may include a data-source stage, a vectorization stage, a dimension-reduction stage, a correlation stage, and an audit stage. The data-source stage may include a first data source 302, a second data source 304, and one or more additional data sources 306. The data sources may correspond to data maintained by different organizations, different repositories, different modalities, or combinations thereof. At the vectorization stage, the first data source 302 may be transformed into a first embedding 312, the second data source 304 may be transformed into a second embedding 314, and the additional data source 306 may be transformed into an embedding n 316. The embeddings may represent vectorized forms of content from respective data sources.

At the dimension-reduction stage, the first embedding 312 may be processed to generate a first nonlinear transformation reducing input into a low-dimensional latent space analysis non-linear transformation (“NLT”) 322, the second embedding 314 may be processed to generate a second NLT 324, and the embedding n 316 may be processed to generate an NLT n 326. In some embodiments, the NLT outputs may correspond to reduced-dimension representations used to reduce processing complexity and to facilitate subsequent correlation processing. NLT may transform high-dimensional data (e.g., embeddings) to a lower-dimensional space to preserve as much variance (e.g., information) as possible. At the correlation stage, the first NLT 322 may be provided to a first spatial discrepancy reduction (“SDR”) 332 produced by a SDR analysis, the second NLT 324 may be provided to a second SDR 334, and the NLT n 326 may be provided to a SDR n 336. SDR may find linear combinations and/or correlations between two sets of vectors (e.g., results of NLT analysis, embeddings) to find sets of directions (e.g., one in each input dataset) such that the projections of the data on the sets of directions are as correlated as possible.

In some embodiments, the non-linear transformation may map an input embedding from an original vector space into a transformed feature space in which non-linear structure within the data becomes more separable, more comparable, or both. The non-linear transformation may be configured to preserve informative semantic relationships while reducing sensitivity to scale differences, sparsity, noise, modality-specific variation, or combinations thereof. In some embodiments, the non-linear transformation may include application of one or more kernel-based mappings, activation functions, learned encoder layers, manifold-preserving transformations, polynomial mappings, radial basis mappings, and/or other non-linear feature generation operations. In some embodiments, the non-linear transformation may generate a transformed representation having a dimensionality lower than, equal to, or higher than a dimensionality of the corresponding embedding, depending on an implementation selected for a particular data environment.

In some embodiments, the non-linear transformation may be used to expose latent structure that is not readily captured by direct comparison of the embeddings 312, 314, and 316 in their original vector spaces. For example, where two data sources encode related information using different vocabularies, different feature distributions, different modalities, and/or different vector-generation pipelines, the non-linear transformation may map the respective embeddings into transformed representations that are more suitable for subsequent alignment. In some embodiments, the non-linear transformation may normalize local neighborhoods, emphasize higher-order semantic relationships, suppress outlier influence, and/or generate transformed coordinates that better reflect an underlying manifold associated with the source data. As a result, transformed representations 322, 324, and 326 may provide a technically improved basis for identifying relationships among data originating from different organizations or different data domains.

At the spatial discrepancy reduction stage, the first transformed representation 322 may be provided to a first spatial discrepancy reduction component 332, the second transformed representation 324 may be provided to a second spatial discrepancy reduction component 334, and the transformed representation 326 may be provided to a spatial discrepancy reduction component 336. In some embodiments, spatial discrepancy reduction may include processing two or more transformed representations to reduce differences between corresponding geometric arrangements of vectors in their respective transformed spaces. Spatial discrepancy reduction may include generating linear combinations of vectors from different transformed representations and identifying pairs of directions, including a first direction from a first transformed representation and a second direction from a second transformed representation, such that projections of vectors onto the pairs of directions are as correlated as possible. In this manner, spatial discrepancy reduction may reduce mismatch between independently generated vector spaces while preserving correspondence between related content items.

In some embodiments, spatial discrepancy reduction may operate to align transformed representations generated from different organizations, different data sets, and/or different modalities by identifying projection directions that maximize inter-dataset correspondence. The resulting aligned subspaces may reduce geometric inconsistency between the transformed representations and may permit vectors derived from different source data to be compared, merged, or used jointly with improved consistency. In some embodiments, spatial discrepancy reduction may include determining one or more correspondence axes, calculating projection values for candidate vector pairs, iteratively adjusting direction vectors to reduce residual mismatch, and/or generating an aligned representation in which semantically related vectors from different data sources occupy more comparable positions. In some embodiments, the spatial discrepancy reduction stage may produce correlation data, aligned coordinates, transformation parameters, projection pairs, and/or other relationship data usable during enrichment of an earlier vector database state to generate a later vector database state.

In some embodiments, a large language model (LLM) may test and verify each spatial discrepancy reduction. In some embodiments, a large language model can be used as a supervisory validation component to test and verify each spatial discrepancy reduction generated during enrichment of a vector database. For example, after a spatial discrepancy reduction operation is performed between a first transformed representation and a second transformed representation, the resulting aligned representation, projection parameters, correspondence pairs, or other reduction outputs may be provided to the large language model together with metadata identifying source data sets, version identifiers, ledger records, and one or more validation criteria. The large language model can then coordinate a sequence of validation operations to determine whether the spatial discrepancy reduction has sufficiently reduced mismatch between the respective vector spaces without introducing unacceptable degradation in retrieval accuracy, semantic consistency, or provenance traceability.

In some embodiments, testing of a given spatial discrepancy reduction can begin by defining a validation set associated with that reduction. The validation set can include matched content pairs, semantically related records, known-answer query pairs, source-grounded prompts, or combinations thereof, where at least some validation items are selected from the first data set, the second data set, or both. The large language model can cause execution of retrieval operations against a pre-reduction vector representation and a post-reduction vector representation and can compare returned results to expected source-grounded answers. In some embodiments, the large language model may determine whether the spatial discrepancy reduction improves cross-dataset retrieval by measuring whether records from the second data set become retrievable in response to queries grounded in the first data set, whether records from the first data set become retrievable in response to queries grounded in the second data set, or both.

In some embodiments, the large language model can test each spatial discrepancy reduction by generating or selecting evaluation prompts that target information expected to become jointly accessible after alignment of the transformed representations. A first subset of prompts can be directed to information already represented in an earlier vector database state, and a second subset of prompts can be directed to information expected to become accessible only after incorporation of the newly aligned data. The large language model may determine whether responses generated using the post-reduction vector database satisfy expected answer criteria for the second subset while preserving correctness for the first subset. In this manner, the large language model may verify that the spatial discrepancy reduction contributes to useful enrichment rather than merely altering vector geometry without improving retrievability.

In some embodiments, the large language model may verify each spatial discrepancy reduction using projection-consistency testing. For example, for each pair of directions identified during the spatial discrepancy reduction, the large language model may cause a validation engine to compute projected values of selected vectors from the first transformed representation and selected vectors from the second transformed representation. The large language model may then compare correlation values, distance values, neighborhood-overlap values, ranking consistency values, or combinations thereof before and after the reduction. If projected vectors associated with semantically corresponding records exhibit increased correlation, reduced spatial divergence, increased nearest-neighbor overlap, and/or improved ranking agreement after the reduction, the large language model may determine that the spatial discrepancy reduction satisfies one or more geometric validation criteria.

In some embodiments, the large language model may test each spatial discrepancy reduction using holdout records not used to generate the reduction. For example, a subset of matched or related records may be withheld during computation of the spatial discrepancy reduction. After the reduction is generated, the large language model may cause the holdout records to be projected into the aligned space and can determine whether corresponding holdout records occupy positions that satisfy one or more acceptance criteria, such as exceeding a similarity threshold, falling within a neighborhood radius, or appearing within a threshold rank among retrieved neighbors. Use of holdout records may reduce risk that the spatial discrepancy reduction merely overfits the records used during alignment.

In some embodiments, the large language model may test each spatial discrepancy reduction through an application programming interface suite. The application programming interface suite may include a plurality of calls associated with known facts, known entities, known relationships, and/or known context fragments that should be retrievable from a particular vector database state. The large language model may invoke the application programming interface suite against a vector database state generated before application of the spatial discrepancy reduction and again against a vector database state generated after application of the spatial discrepancy reduction. The large language model may determine whether one or more previously failing calls now pass after application of the spatial discrepancy reduction, while previously passing calls continue to pass. Such behavior may indicate that the reduction has increased completeness of the vector database without materially degrading preexisting retrieval capability.

In some embodiments, the large language model may also test for hallucinations attributable to a spatial discrepancy reduction. For example, the large language model may compare a generated answer against source passages, source records, ledger-linked provenance metadata, or combinations thereof. If the aligned vector space causes retrieval of records that do not support a generated answer, or causes blending of unrelated concepts from different data sets, the large language model may flag the corresponding spatial discrepancy reduction as suspect. In some embodiments, hallucination testing may include determining whether an answer cites or relies upon records that are absent from the retrieved context, whether the answer incorrectly merges attributes of distinct records, and/or whether the answer asserts relationships not supported by the underlying source data. A spatial discrepancy reduction may be rejected, rolled back, and/or marked for retraining if hallucination frequency exceeds a threshold.

In some embodiments, the large language model may verify provenance and authenticity associated with each spatial discrepancy reduction by consulting a distributed ledger. For example, each reduction output may be associated with a ledger entry including a checksum, version identifier, timestamp, source-data identifier, transformation parameters, reduction parameters, or combinations thereof. The large language model may cause retrieval of a ledger record corresponding to a tested spatial discrepancy reduction and may compare a checksum of the locally tested reduction artifact to a checksum stored in the distributed ledger. The large language model may thereby determine whether the reduction artifact being tested corresponds to an authenticated and expected version of the reduction artifact. In some embodiments, the large language model may refuse to validate a reduction result unless the reduction result matches the ledger-stored record.

In some embodiments, the large language model may assign a composite verification score to each spatial discrepancy reduction. The composite verification score may be based on multiple criteria, including cross-dataset retrieval improvement, projection correlation improvement, neighborhood-preservation behavior, holdout performance, application programming interface pass-rate improvement, hallucination rate, provenance consistency, or combinations thereof. Each criterion may be weighted according to system requirements. A spatial discrepancy reduction may be accepted for use in generating a later vector database state if the composite verification score satisfies an acceptance threshold, and may otherwise be rejected, quarantined, and/or subjected to further processing.

In some embodiments, the large language model may test and verify each spatial discrepancy reduction iteratively during a multi-stage enrichment pipeline. For example, where a first vector database is successively enriched using multiple incoming data sets, the large language model may separately evaluate a first spatial discrepancy reduction between a first pair of transformed representations, a second spatial discrepancy reduction between a later pair of transformed representations, and/or additional reductions for later-added data sets. The large language model may maintain a per-reduction validation history in the distributed ledger so that a later audit can identify which particular reduction contributed to a retrieval improvement, a hallucination event, a provenance mismatch, and/or another performance change. This per-reduction verification may permit granular rollback of a problematic spatial discrepancy reduction without discarding all prior enrichment stages.

In some embodiments, the large language model need not directly compute the spatial discrepancy reduction itself, but can instead orchestrate specialized scoring modules, retrieval engines, projection evaluators, and ledger-verification services to determine whether the reduction is acceptable. Thus, the large language model can function as an intelligent testing controller that interprets expected semantic behavior, initiates technical validation routines, compares pre-reduction and post-reduction outcomes, checks source grounding and provenance, and determines whether each spatial discrepancy reduction should be approved for incorporation into a later vector database state.

The outputs of the spatial discrepancy reduction stage may be recorded as first stored relationships 342, second stored relationships 344, and stored relationships 346 in a distributed ledger 350. In some embodiments, the distributed ledger 350 may store transformation parameters associated with the non-linear transformation stage, alignment parameters associated with the spatial discrepancy reduction stage, checksums, version identifiers, timestamps, source identifiers, or combinations thereof. Storage in the distributed ledger 350 may permit subsequent retrieval of intermediate relationship data used to enrich a vector database and may support auditability, traceability, and authenticity verification. In some embodiments, when a later vector database state is generated, a computing system may retrieve one or more of the stored relationships 342, 344, or 346 and may use the retrieved relationships to verify how vectors from different data sources were aligned and incorporated into the later vector database state.

As further shown in FIG. 3, outputs of the dimension-reduction stage may be cross-coupled to correlation components so that relationships among different reduced representations may be identified. The correlation stage may generate correlation information representing relationships among vectors or subspaces derived from different data sources.

In some embodiments, the audit stage may include a distributed ledger 350 that stores correlation outputs generated by the correlation stage. For example, first stored correlations 342, second stored correlations 344, and stored correlations n 346 may be recorded in the distributed ledger 350. The stored correlations may be retrieved to verify authenticity, trace progression of enrichment, and/or reconstruct how information from different data sources contributed to a given vector database state. Accordingly, FIG. 3 illustrates an example architecture in which multiple data sources are vectorized, reduced in dimension, processed to determine correlations, and then preserved in a distributed ledger to support later audit and traceability. In some embodiments, one or more of the correlation results stored in the distributed ledger 350 may be used during enrichment of an earlier vector database state to generate a later vector database state.

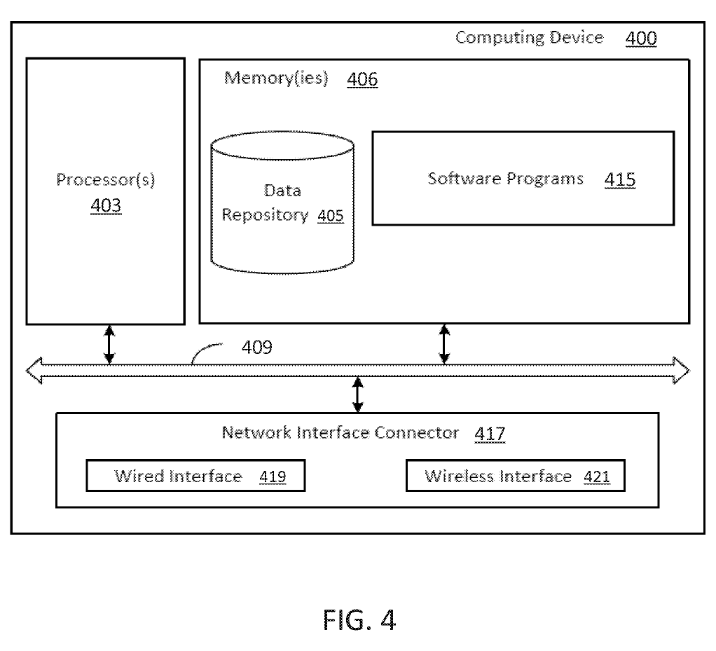

FIG. 4 is a block diagram of a computing device for implementing certain aspects of the present disclosure. FIG. 4 depicts exemplary computing device 400. Computing device 400 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 400.

Computing device 400 includes a processor 403 coupled to a memory 406. Memory 406 may include volatile memory and/or persistent memory. The processor 403 executes computer-executable program code stored in memory 406, such as software programs 415. Software programs 415 may include one or more of the logical steps disclosed herein as a programmatic instruction, which may be executed by processor 403. Memory 406 may also include data repository 405, which may be nonvolatile memory for data persistence. The processor 403 and the memory 406 may be coupled by a bus 409. In some examples, the bus 409 may also be coupled to one or more network interface connectors 417, such as wired network interface 419, and/or wireless network interface 421. Computing device 400 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A computer-implemented method for incrementally enriching a vector database across organizational computing systems while preserving retrievability and auditability of intermediate vector database states, the computer-implemented method comprising:
receiving, by a first computing system comprising at least one processor, a first data set associated with a first organization;
generating, by the first computing system, a first vector database from the first data set, the first vector database comprising a first set of vectors;
storing, by the first computing system, the first vector database in a distributed ledger;
transmitting, by the first computing system, the first vector database from the first computing system to a second computing system associated with a second organization;
receiving, by the second computing system, a second data set associated with the second organization, the second data set comprising a second set of vectors;
performing, by the second computing system, a correlation operation on the first set of vectors and the second set of vectors by generating linear combinations of the first set of vectors and the second set of vectors and identifying pairs of directions, including a first direction from the first set of vectors and a second direction from the second set of vectors, such that projections of the first set of vectors and the second set of vectors onto the pairs of directions are more correlated;
enriching, by the second computing system, the first vector database with the second data set based on the correlation operation to generate a second vector database;
storing, by the second computing system, the second vector database in the distributed ledger; and
retrieving, by at least one of the first computing system or the second computing system, the first vector database or the second vector database from the distributed ledger.

2. The computer-implemented method of claim 1, wherein the distributed ledger comprises a federated distributed ledger.

3. The computer-implemented method of claim 1, further comprising performing a checksum check on the first vector database after the transmitting and before the enriching.

4. The computer-implemented method of claim 1, wherein the enriching comprises using the first vector database as an input to generate the second vector database.

5. The computer-implemented method of claim 1, wherein the performing of the correlation operation comprises generating a first linear combination of vectors from the first set of vectors and a second linear combination of vectors from the second set of vectors.

6. The computer-implemented method of claim 1, wherein the identifying of the pairs of directions comprises selecting a pair of directions having a correlation between projections of the first set of vectors and the second set of vectors that is greater than correlations for other candidate pairs of directions in a plurality of candidate pairs of directions.

7. The computer-implemented method of claim 1, wherein the retrieving comprises retrieving a selected one of the first vector database or the second vector database from the distributed ledger and comparing a checksum of the selected vector database with a checksum associated with the distributed ledger to verify authenticity of the selected vector database.

8. The computer-implemented method of claim 1, further comprising executing an application programming interface suite against the first vector database, wherein a first subset of application programming interface calls passes and a second subset of application programming interface calls fails.

9. The computer-implemented method of claim 8, further comprising executing the application programming interface suite against the second vector database, wherein application programming interface calls in the application programming interface suite pass.

10. The computer-implemented method of claim 1, further comprising validating the second vector database using an approximate neighbor-search library.

11. A system for incrementally enriching a vector database across organizational computing systems while preserving retrievability and auditability of intermediate vector database states, the system comprising:
a first computing system comprising at least one first processor and at least one first memory, the first computing system being configured to receive a first data set associated with a first organization, generate a first vector database from the first data set, the first vector database comprising a first set of vectors, store the first vector database in a distributed ledger, and transmit the first vector database from the first computing system to a second computing system associated with a second organization;
a second computing system comprising at least one second processor and at least one second memory, the second computing system being configured to receive the first vector database from the first computing system and receive a second data set associated with the second organization, the second data set comprising a second set of vectors;
a distributed ledger configured to store the first vector database and the second vector database; and
wherein the second computing system is further configured to perform a correlation operation on the first set of vectors and the second set of vectors by generating linear combinations of the first set of vectors and the second set of vectors and identifying pairs of directions, including a first direction from the first set of vectors and a second direction from the second set of vectors, such that projections of the first set of vectors and the second set of vectors onto the pairs of directions are more correlated, enrich the first vector database with the second data set based on the correlation operation to generate the second vector database, store the second vector database in the distributed ledger, and retrieve the first vector database or the second vector database from the distributed ledger.

12. The system of claim 11, wherein the distributed ledger comprises a federated distributed ledger.

13. The system of claim 11, wherein the second computing system is further configured to perform a checksum check on the first vector database after receipt of the first vector database and before generation of the second vector database.

14. The system of claim 11, wherein the second computing system is further configured to use the first vector database as an input to generate the second vector database.

15. The system of claim 11, wherein the second computing system is further configured to generate a first linear combination of vectors from the first set of vectors and a second linear combination of vectors from the second set of vectors during the correlation operation.

16. The system of claim 11, wherein the second computing system is further configured to retrieve a selected one of the first vector database or the second vector database from the distributed ledger and compare a checksum of the selected vector database with a checksum associated with the distributed ledger to verify authenticity of the selected vector database.

17. The system of claim 11, further comprising an application programming interface suite configured to query the first vector database and the second vector database, wherein a first subset of application programming interface calls is configured to pass against the first vector database, a second subset of application programming interface calls is configured to fail against the first vector database, and the application programming interface suite is configured to pass against the second vector database.

18. A non-transitory computer-readable medium storing instructions that, when executed by one or more processors, cause the one or more processors to perform operations for incrementally enriching a vector database across organizational computing systems while preserving retrievability and auditability of intermediate vector database states, the operations comprising:
receiving a first data set associated with a first organization;
generating a first vector database from the first data set, the first vector database comprising a first set of vectors;
storing the first vector database in a distributed ledger;
transmitting the first vector database to a second computing system associated with a second organization;
receiving a second data set associated with the second organization, the second data set comprising a second set of vectors;
performing a correlation operation on the first set of vectors and the second set of vectors by generating linear combinations of the first set of vectors and the second set of vectors and identifying pairs of directions, including a first direction from the first set of vectors and a second direction from the second set of vectors, such that projections of the first set of vectors and the second set of vectors onto the pairs of directions are more correlated;
enriching the first vector database with the second data set based on the correlation operation to generate a second vector database;
storing the second vector database in the distributed ledger; and
retrieving the first vector database or the second vector database from the distributed ledger.

19. The non-transitory computer-readable medium of claim 18, wherein the operations further comprise selecting a pair of directions having a correlation between projections of the first set of vectors and the second set of vectors that is greater than correlations for other candidate pairs of directions in a plurality of candidate pairs of directions.

20. The non-transitory computer-readable medium of claim 18, wherein the operations further comprise executing an application programming interface suite against the first vector database and the second vector database to determine that a first subset of application programming interface calls passes and a second subset of application programming interface calls fails for the first vector database and that application programming interface calls in the application programming interface suite pass for the second vector database.
